(19) United States
(12) Patent Application Publication
(10) Pub. No.: US 2015/0048203 A1
(43) Pub. Date: Feb. 19, 2015

(54) PAYLOAD SUSPENSION FOR LIGHTER-THAN-AIR STRUCTURES

(71) Applicant: Altaeros Energies, Inc., Somerville, MA (US)

(72) Inventor: Benjamin W. Glass, Somerville, MA (US)

(21) Appl. No.: 14/381,000

(22) PCT Filed: Feb. 25, 2013
(86) PCT No.: PCT/US2013/027650

§ 371 Date: Aug. 26, 2014

Related U.S. Application Data
(60) Provisional application No. 61/603,355, filed on Feb. 26, 2012.

(51) Int. Cl. B64D 9/00; B64B 1/50

(52) U.S. Cl. CPC B64D 9/00; B64B 1/50
USPC 244/118.1

(57) ABSTRACT

This invention provides a configuration of suspension lines, anchored with respect to an inner surface of an LTA structure, and which provide reactive forces between an LTA structure and its payload so as to constrain the translational and rotational motion of the payload to be nearly rigid with respect to the LTA structure. Illustratively, the configuration constrains the motion of the payload with respect to the LTA structure along all six degrees of freedom: e.g. horizontal, vertical and longitudinal translation and rotation about the longitudinal, horizontal and vertical axes.

### FIELD OF THE INVENTION

The present invention relates to the suspension, or mounting, of payloads within an annular or closed section of a lighter-than-air (LTA) structure.

### BACKGROUND OF THE INVENTION

Aerostats, or moored balloons, are finding increasing use in applications as diverse as surveillance, weather monitoring and renewable energy. Their inherent reliability, low cost and ability to loiter on station for long durations with minimal maintenance or fuel use provide a unique combination of capabilities unmatched by heavier-than-air flight vehicles or satellites.

Many of the current aerostat applications require the lifting of payloads in excess of several hundred pounds. Payloads can include radar systems, telecommunication systems, power generation and power conditioning equipment, etc. Such payloads must be properly secured and stabilized onboard the aerostat in order to perform their desired function. In particular, there are efforts to incorporate rotating turbines within aerostats for wind energy generation. By way of useful background information, such an application is shown and described in commonly assigned U.S. Pat. No. 8,253,265, entitled POWER AUGMENTING SHROUD, by Ben Glass, the teachings of which are incorporated herein by reference. For this application, the turbine payload must be nearly rigidly secured to the aerostat to maintain small tip clearances with respect to the inner surface of the annular aerostat shroud, and to transmit both the motion of the aerostat to the turbine and the turbine torque to the aerostat. Current aerostat payload suspension systems do not adequately restrain the payload in all six degrees of freedom for these new applications.

### SUMMARY OF THE INVENTION

This invention overcomes disadvantages of the prior art by providing an improved retaining mechanism that suspends the payload within an annular or closed section of an aerostat. The illustrative suspension system is constructed and arranged so as to constrain the translational and rotational motion of the payload to be nearly rigid with respect to the LTA structure, making it suitable for contemporary, innovative aerostat applications, such as wind energy generation.

In an illustrative embodiment a system, and associated method, for suspending a payload with respect to an inner surface of a lighter-than-air (LTA) structure defining a longitudinal axis, a horizontal axis and a vertical axis is provided. A configuration of suspension lines extends between attachment locations on the inner surface and attachment locations on the payload. The configuration is constructed and arranged to provide reactive forces between the LTA structure and the payload so as to constrain translational and rotational motion of the payload. In this manner, the configuration defines a substantially rigid relationship with respect to the LTA structure. Illustratively, the configuration is constructed and arranged so that longitudinal translation is constrained by a balance of longitudinal forces in an opposing set of forward-facing suspension lines and aft-facing suspension lines. In addition, horizontal translation is constrained by a balance of side-to-side forces in a set of port side-facing suspension lines and a set of starboard side-facing suspension lines, and vertical translation is constrained by a balance of vertical forces in a set of upward-facing suspension lines and downward-facing suspension lines. Also, rotation about the longitudinal axis is constrained by a balance of moments produced by circumferential forces in at least four of the suspension lines that are each attached to the payload substantially remote from the longitudinal axis and which define a substantial circumferential component of direction, and rotation about the horizontal axis is constrained by a balance of moments produced by a vertical component of force in forward suspension lines and aft suspension lines. More generally, the configuration of suspension lines includes a plurality of lines extending from forward to aft, and wherein the attachment locations on the payload are located remote from the longitudinal axis and so as to generate a substantial circumferential moment, the suspension lines constructed and arranged to constrain motion of the payload with respect to the LTA structure in at least six degrees of freedom. This illustrative configuration of suspension lines includes at least one set of (a) aft-directed suspension lines attached to forward locations on the payload and forward-directed suspension lines attached to aft locations on the payload, (b) forward-directed suspension lines attached to forward locations on the payload and aft-directed suspension lines attached to aft locations on the payload, (c) aft-directed suspension lines and forward-directed suspension lines attached to forward locations on the payload and, (d) aft-directed suspension lines and forward-directed suspension lines attached to aft locations on the payload. In various embodiments, the LTA structure can define an open, annular shroud or a traditional enclosed shell.

### BRIEF DESCRIPTION OF THE DRAWINGS

The invention description below refers to the accompanying drawings, of which

FIG. 1 frontal perspective view of an annular LTA structure with an associated eight-line suspension system for a contained payload, according to an illustrative embodiment;

FIG. 2 is an exposed side view of the LTA structure and suspension system of FIG. 1;

FIG. 3 is a frontal perspective view of an annular LTA structure with an associated sixteen-line suspension system for a contained payload, providing increased support-redundancy, according to an alternate embodiment;

FIG. 4 is an exposed side view of the LTA structure and suspension system of FIG. 3;

FIG. 5 is an exposed perspective view of a traditional enclosed LTA structure with a payload contained therein, supported by a sixteen-line suspension system according to an illustrative embodiment;

FIGS. 6(a)-6(c) are each schematic representations of differing support geometries for a payload with respect to the inner surface of an LTA structure, according to illustrative embodiments; and

FIG. 7 is a front schematic cross section of an LTA structure employing a sixteen line suspension system, such as shown in FIG. 5, in which each line is anchored to the LTA inner surface at a location remote from the LTA structure's longitudinal axis, and with a substantial circumferential component of direction.

### DETAILED DESCRIPTION

Suspension System Configuration

The illustrative embodiments of the present invention provide an improved configuration of suspension lines for the suspension of a payload within (and with respect to the inner surface of) an LTA structure consisting of an outer annular or closed section of the LTA vehicle, the payload located within the annular or closed LTA section and at least eight suspension lines connected between the LTA vehicle and the payload. The payload can be contained within the enclosed volume of lighter-than-air gas, such as in a traditional aerostat, in which the envelope forms a closed section about the gas and payload, or outside of the enclosed volume of lighter-than-air gas, such as within the central section of an annular shaped aerostat. The suspension lines are typically composed of rope or other (typically) linearly extended structural elements that can resist a predetermined tensile load, and which can be packaged into a small volume when the LTA structure is packed down, such as for storage or transportation. The configuration of the suspension lines provide reactive forces between the payload and LTA structure so as to constrain the translational and rotational motion of the payload to be nearly rigid with respect to the LTA structure. This nearly rigid motion is maintained for external forces applied to the LTA structure, the payload or any combination thereof. In an embodiment, preload is applied to each suspension line, either through adjustment of the lengths of the suspension lines or by action of the inflation of the

LTA structure, such that each suspension line maintains a non-zero amount of tensile load in all design load cases.

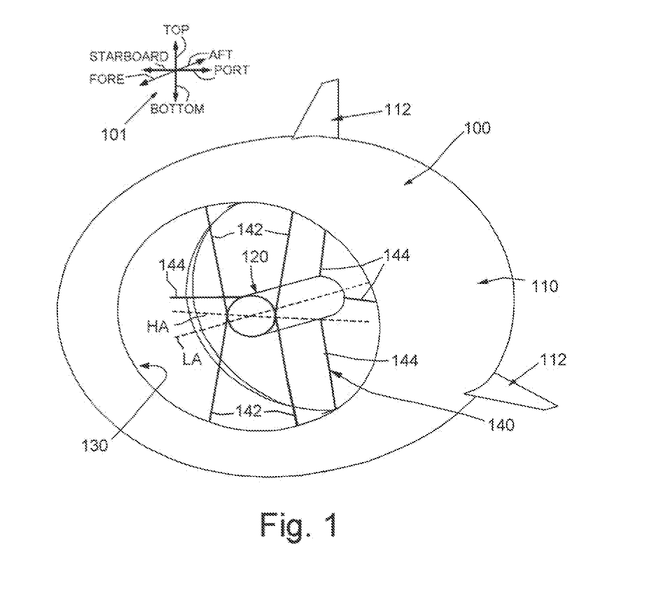

With reference to FIG. 1, the system's (100) longitudinal axis LA, forward (fore), aft, upper/top, lower/bottom, starboard and port portion of the LTA structure and forward and aft portion of the payload are defined below by the depicted axes 101.

FIG. 1 depicts an LTA structure 100 that can be similar in design and function to that of the above-incorporated U.S. Pat. No. 8,253,265. This LTA structure defines an exemplary annular shroud 110 and associated stabilizing fins. The shroud can define an appropriate aerodynamic cross section for enhanced lift according to various embodiments. The interior of the LTA structure 100 and associated shroud 110 can surround a payload 120. By way of illustration of the broader concept, the payload 120 in this embodiment defines a simplified cylinder of predetermined diameter. In various embodiments, the payload can be the supporting arrangement of a turbine, an instrumentation package, or any other arrangement adapted to fit within the perimeter boundary of the inner surface 130 of the LTA structure 100.

Notably, the payload 120 is secured against relative translation and motion with respect to the LTA structure 100 and shroud 110 by a system of suspension lines 140. In this embodiment the suspension lines are arranged such that at least four suspension lines 142 are attached at a substantially forward portion of the payload and at least four suspension lines 144 are attached at a substantially aft portion of the payload, with a substantial separation between the forward and aft suspension lines(with “fore” or “forward” being defined as more remote from the stabilizing fins 112 and “aft” or “rear” being defined as more proximate the stabilizing fins and more generally with the direction of any relative wind moving from fore to aft across the LTA structure 100).

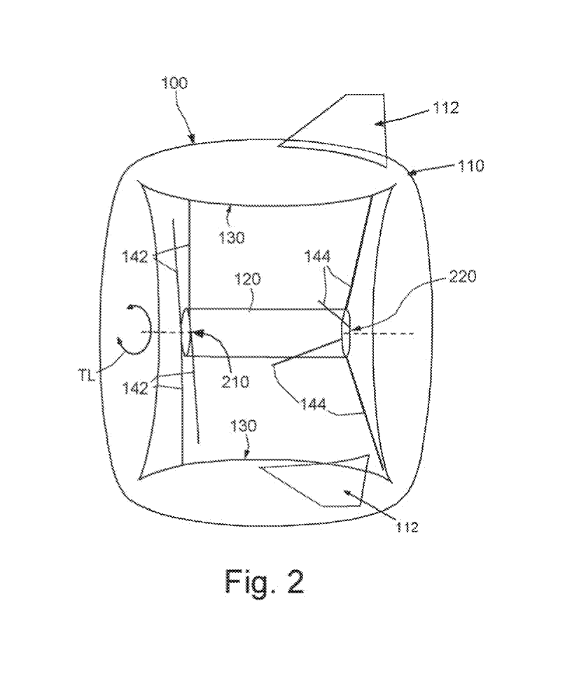

The suspension lines 142, 144 of the suspension system of this embodiment are arranged such that at least four the suspension lines are attached to the payload 120 in a manner that each of their respective vectors is substantially separate/remote from the longitudinal axis LA of the payload, and each line's vector is directed substantially circumferentially about that longitudinal axis. With further reference to FIG. 2, this arrangement causes each vector to illustratively impart a rotational torque (curved arrow TL) on the payload 120 about the longitudinal axis LA. At least two of these suspension lines are arranged such that the circumferential component of their direction is oriented clockwise and at least two of these suspension lines are arranged such that the circumferential component of their direction is oriented anti-clockwise. A minimum of two clockwise oriented and two anti-clockwise oriented suspension lines are illustratively attached at either the forward portion 210 of the payload 120 or the aft portion 220 of the payload. If additional suspension lines with significantly circumferential orientation are used, such lines can be attached at the other of the forward or aft portion of the payload 120. The illustrative suspension lines are arranged such that at least two suspension lines are attached such as to have an upward component of their direction from the payload, with at least one of these upward pointing suspension lines at each of the forward and aft portions of the payload.

Note, as used herein, various directional and orientational terms such as “vertical”, “horizontal”, “up”, “down”, “bottom”, “top”, “side”, “front”, “rear”, “left”, “right”, and the like, are used only as relative conventions and not as absolute orientations with respect to a fixed coordinate system, such as the acting direction of gravity.

As depicted in FIGS. 1 and 2, an in accordance with illustrative embodiments, the following general line configuration principles apply to the suspension system: (1) The suspension lines 142, 144 are arranged such that at least two suspension lines are attached such as to have a downward component of their direction from the payload, with at least one of these downward pointing suspension lines at each of the forward and aft portions of the payload. Likewise, the suspension lines 142, 144 are arranged such that at least two suspension lines are attached so as to have a starboard(right)-pointing component of their direction from the payload, with at least one of these starboard-pointing suspension lines at each of the forward and aft portions of the payload. (2) The suspension lines are arranged such that at least two suspension lines are attached such as to have a port (left)-pointing component of their direction from the payload, with at least one of these port-pointing suspension lines at each of the forward and aft portions of the payload. (3) The suspension lines are also arranged such that at least two of the suspension lines are directed significantly forward, such that their attachment point on the LTA structure is forward of their attachment point on the payload, and at least two of the suspension lines are directed significantly aft, such that their attachment point on the LTA structure is aft of their attachment point on the payload. (4) The suspension lines are, more generally, arranged such that the net circumferential direction of the forward directed suspension lines is zero and the net circumferential direction of the aft directed suspension lines is zero, so as to not impart a torque upon the payload when the forward or aft directed suspension lines react a longitudinal force. Note, as defined herein for the above-described line-configuration principles, the direction, pointing or facing of a suspension line refers to the direction from the attachment point on the payload to the attachment point on the LTA structure. Furthermore, a single suspension line can include components of direction substantially in multiple directions (e.g. upward, rearward and starboard, in combination).

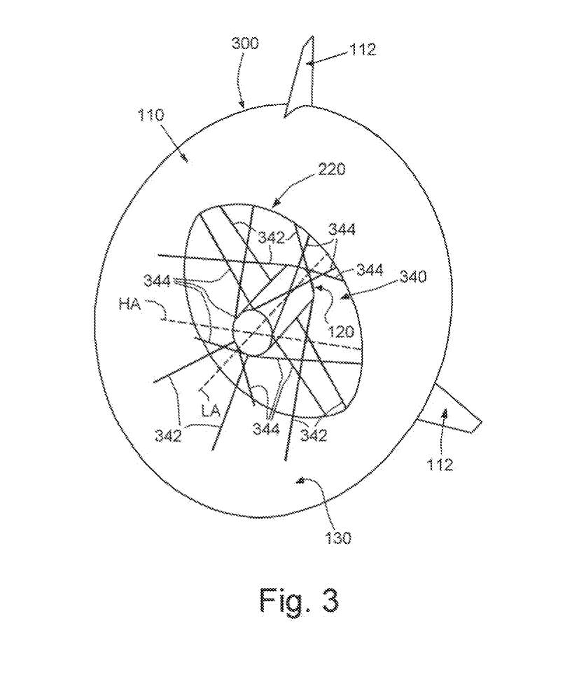

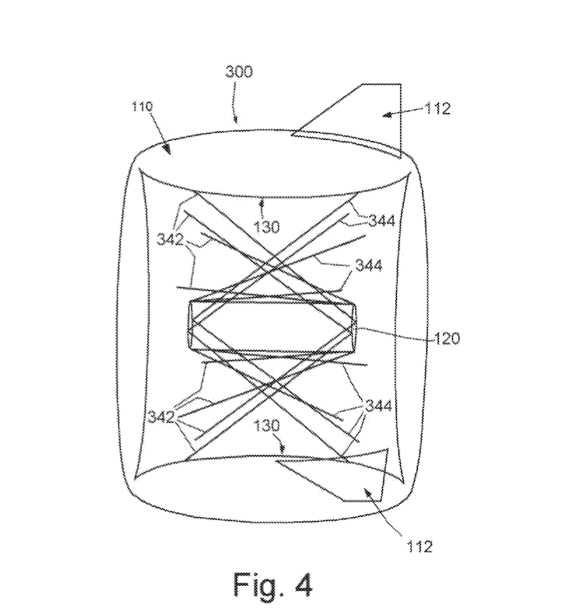

FIGS. 3 and 4 depict a further embodiment of a payload (120) suspension system 300 employing the above-described LTA shroud 110 constructed in the same or similar manner as the shroud 110 of FIG. 1, and thus, like reference numbers refer to like elements in each embodiment. The arrangement of suspension lines 342 and 344 comprises sixteen total lines, in which eight lines 342 extend from the forward side of the shroud inner surface 130 to the aft side of the payload and another eight lines 344 extend from the aft side of the shroud inner surface 130 to the forward side of the payload 120. The lines of the embodiment of FIGS. 3-4 are arranged in accordance with the general line-configuration principles described above. More generally, like the embodiment of FIGS. 1-2, the lines generate a plurality of force vectors acting in various directions remote from (non-aligned with) the longitudinal axis LA.

In this embodiment, the arrangement of suspension lines 342 and 344 is adapted to provide redundancy to the above-described eight-line arrangement of FIGS. 1-2. The illustrative sixteen-line arrangement essentially doubles the suspension lines in use and further insures a rigid suspension and static payload with respect to the surrounding LTA structure. The number of lines, while depicted as sixteen, can be varied to be more or less than sixteen in alternate embodiments.

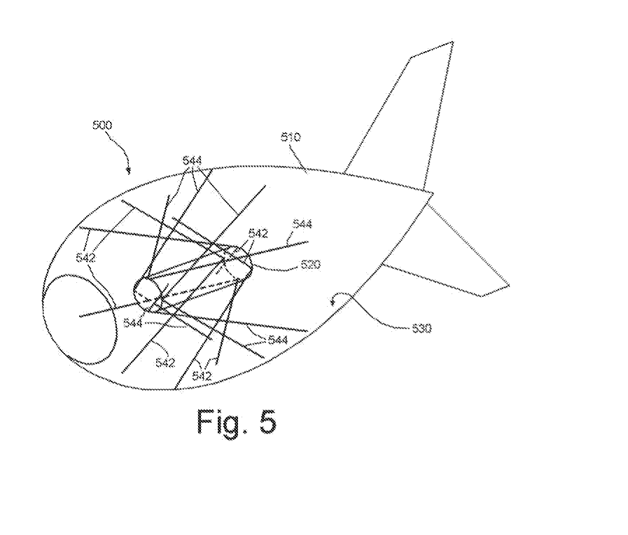

With brief reference to FIG. 5, a traditional enclosed LTA system 500 is depicted. This LTA structure is in the form of a traditional aerostat or similar structure having a general teardrop shape with a bulbous forward section and tapered aft section. This shape is defined by a sealed, fully enclosed outer shell 510 that contains a lighter-than-air gas, potentially comprising a plurality of layers, including a layer defining an inner surface 530 adapted (like the shroud inner surface 130) to assist in supporting a plurality of suspension lines 542 and 544 that engage a payload 520. The payload 520 is depicted as fully contained within the shell 510. The lines 542 and 544 are arranged generally in a manner similar to that described with respect to the lines (342 and 344, respectively) of the embodiment of FIGS. 3-4. As such, the lines constrain motion and maintain rigid support of the payload 520 with respect to the LTA structure.

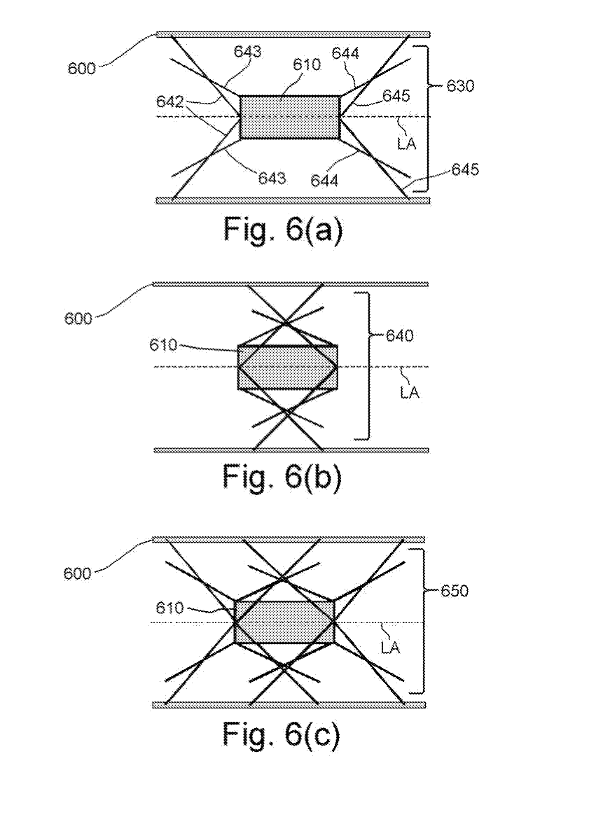

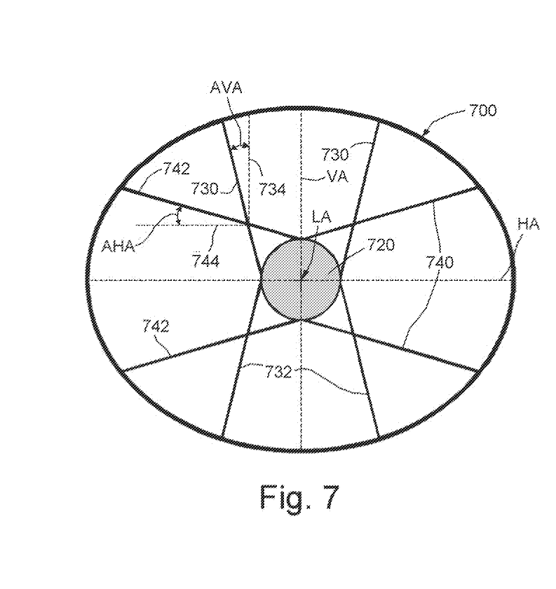

Reference is now made to FIGS. 6(a)-6(c), which respectively show various line-suspension configurations in schematic side view. As shown in FIG. 6(a) the LTA structure 600 (according to any embodiment herein) contains the payload 620 using a suspension line configuration 630 consisting of 8-16 (or more) forward lines (attached to the payload 620) that are directed to attachment locations/points forward on the LTA structure; and 8-16 (or more) aft lines (attached to the payload 620) that are directed to attachment locations/points rearward/aft on the LTA structure. In FIG. 6(b) the suspension line configuration 640 consists of 8-16 (or more) forward lines (attached to the payload 620) that are directed to attachment locations/points rearward/aft on the LTA structure; and 8-16 (or more) aft lines (attached to the payload 620) that are directed to attachment locations/points forward on the LTA structure. In FIG. 6(c), the suspension line configuration 650 consists of a combination of the system arrangements 630 (FIGS. 6(a)) and 640 (FIG. 6(b)). Thus, the system includes a combination of (i) forward-located, forward-facing lines, (ii) aft-located, aft-facing lines, (iii) forward-located, aft-facing lines, and (iv) aft-located, forward-facing lines. In further embodiments, one of the arrangements (i)-(iv) can be omitted. Likewise, the number of lines used in each arrangement (i)-(iv) can vary. In each of the illustrative configurations 630-650, all suspension lines define a significant circumferential component of their direction. This is shown with further reference to the front view of an exemplary LTA structure 700 in FIG. 7. The depicted line attachment points are substantially separated from the longitudinal axis LA by a combination of upper-facing lines 730, lower-facing lines 732, and side-directed lines 740. The upward-facing lines 730 and downward-facing lines 732 each reside at an acute angle AVA with respect to the vertical axis (VA) direction (i.e. a line 734 perpendicular to the horizontal axis HA). In various embodiments AVA can be between approximately 0 and 45 degrees, but other measurements are expressly contemplated including a straight vertical orientation. Likewise, the port side-facing lines 740 and starboard side-facing lines 742 each reside at an acute angle AHA with respect to a line 744 parallel to the horizontal axis HA. The value for AHA is highly variable, but can be between approximately 10 and 30 degrees in various embodiments.

Operation

In operation, the suspension line system of the various embodiments described above effectively constrains the motion of the payload (e.g. payload 120 in FIG. 1) with respect to the LTA structure (e.g. LTA shroud 110 in FIG. 1) along all six degrees of freedom: horizontal, vertical and longitudinal translation and rotation about the longitudinal (LA), horizontal (HA) and vertical (VA) axes. The length of each suspension line is such that in the deployed configuration without external load each suspension line is subject to a predetermined level of tensile load, or “preload”, such that it will maintain at least some tension during all design load scenarios to which the LTA structure will likely be subjected. This preload can be provided by the inflation of the LTA structure (which can expand the distance between locations on the inner surface) or by a mechanism that allows adjustment of the length of the suspension lines, such as, but not limited to, turnbuckles. The following payload-constraining functions are accomplished by one or more particular suspension line arrangement(s) as illustrated generally in FIGS. 6(a)-6(c) and FIG. 7.

Longitudinal Translation: Longitudinal translation along longitudinal axis LA is constrained by the balance of longitudinal forces in at least two forward-facing suspension lines (e.g. lines 642, 643 in FIG. 6(a)) and at least two aft-facing suspension lines (e.g. lines 644, 645 in FIG. 6(a)).

Horizontal Translation: Horizontal translation along the horizontal axis HA is constrained by the balance of side-to-side forces in at least two port side-facing suspension lines (e.g. lines 740 in FIG. 7) and at least two starboard side-facing suspension lines (e.g. lines 742 in FIG. 7).

Vertical Translation: Vertical translation along the vertical axis VA is constrained by the balance of vertical forces in at least two upward-facing suspension lines (e.g. lines 730 in FIG. 7) and at least two downward-facing suspension lines (e.g. lines 732 in FIG. 7).

Longitudinal Axis Rotation: Rotation (e.g. arrow T in FIG. 2) about the longitudinal axis LA is constrained by the balance of moments produced by the circumferential forces in the at least four suspension lines (e.g. lines 730, 732, 740, and 742 in FIG. 7), which are attached substantially separate from the longitudinal axis and which have a significant circumferential component of direction.

Horizontal Axis Rotation: Rotation about the horizontal axis HA is constrained by the balance of moments produced by vertical forces in the set of upward-facing suspension line(s) attached at the forward portion of the payload and downward-facing suspension line(s) attached at the aft portion of the payload or by the set of downward facing suspension line(s) attached at the forward portion of the payload and upward facing suspension line(s) attached at the aft portion of the payload.

Vertical Axis Rotation: Rotation about the vertical axis VA is constrained by the balance of moments produced by horizontal forces in the set of port side-facing suspension line(s) attached at the forward portion of the payload and starboard side-facing suspension line(s) attached at the aft portion of the payload or by the set of starboard side-facing suspension line(s) attached at the forward portion of the payload and port side-facing suspension line(s) attached at the aft portion of the payload.

Through combination of the above forces and moments, employing the above-described novel suspension line system, substantially all motion of the payload is effectively constrained with respect to the LTA structure.

When the LTA structure is packaged for storage or transportation, the suspension lines can be folded along with the LTA structure in such manner as to minimize the packaged volume of the LTA structure and payload suspension, allowing easier storage and transportation logistics. By maintaining the attachment of the payload suspension lines with the payload and LTA structure in the packaged condition, the deployment of the LTA structure and payload can also be made less labor and/or time-intensive, with minimal additional steps employed in the field for mounting the payload.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments.

Furthermore, while the foregoing describes a number of separate embodiments of the apparatus and method of the present invention, what has been described herein is merely illustrative of the application of the principles of the present invention. For example, while lines are shown attached to the forward and rear ends of the payload, it is expressly contemplated that some or all lines can be attached to locations inboard of the forward and/or rear ends. Also, while a braided rope or cable is used as a suspension line in this embodiment, a monofilament line can be employed in alternate embodiments. The lines can be constructed from polymer, composite, metal or a combination of such materials. In addition, lines can be rigid or semi-rigid in various embodiments—such as carbon-fiber and/or fiberglass shafts of gimbaled mounting points. Accordingly, this description is meant to be taken only by way of example, and not to otherwise limit the scope of this invention.

What is claimed is:

1. A system for suspending a payload with respect to an inner surface of a lighter-than-air (LTA) structure defining a longitudinal axis, a horizontal axis and a vertical axis comprising:
a configuration of suspension lines, extending between attachment locations on the inner surface and attachment locations on the payload, constructed and arranged to provide reactive forces between the LTA structure and the payload so as to constrain translational and rotational motion of the payload to define a substantially rigid relationship with respect to the LTA structure.

2. The system as set forth in claim 1 wherein the configuration is constructed and arranged so that longitudinal translation is constrained by a balance of longitudinal forces in an opposing set of forward-facing suspension lines and aft-facing suspension lines.

3. The system as set forth in claim 1 wherein the configuration is constructed and arranged so that horizontal translation is constrained by a balance of side-to-side forces in a set of port side-facing suspension lines and a set of starboard side-facing suspension lines.

4. The system as set forth in claim 1 wherein the configuration is constructed and arranged so that vertical translation is constrained by a balance of vertical forces in a set of upward-facing suspension lines and downward-facing suspension lines.

5. The system as set forth in claim 1 wherein the configuration is constructed and arranged so that rotation about the longitudinal axis is constrained by a balance of moments produced by circumferential forces in at least four of the suspension lines that are each attached to the payload substantially remote from the longitudinal axis and which define a substantial circumferential component of direction.

6. The system as set forth in claim 1 wherein the configuration is constructed and arranged so that rotation about the horizontal axis is constrained by a balance of moments produced by a vertical component of force in forward suspension lines and aft suspension lines.

7. The system as set forth in claim 1 wherein the configuration is constructed and arranged so that rotation about the vertical axis is constrained by a balance of moments produced by a horizontal component of force in forward suspension lines and aft suspension lines.

8. The system as set forth in claim 1 wherein the configuration of suspension lines includes a plurality of lines extending from forward to aft, and wherein the attachment locations on the payload are located remote from the longitudinal axis and so as to generate a substantial circumferential moment, the suspension lines constructed and arranged to constrain motion of the payload with respect to the LTA structure in at least six degrees of freedom.

9. The system as set forth in claim 8 wherein the configuration of suspension lines includes at least one set of (a) aft-directed suspension lines attached to forward locations on the payload and forward-directed suspension lines attached to aft locations on the payload, and (b) forward-directed suspension lines attached to forward locations on the payload and aft-directed suspension lines attached to aft locations on the payload.

10. The system as set forth in claim 1 wherein the LTA structure defines an annular shroud.

11. A method for suspending a payload with respect to an inner surface of a lighter-than-air (LTA) structure defining a longitudinal axis, a horizontal axis and a vertical axis, comprising the steps of:
extending suspension lines between attachment locations on the inner surface and attachment locations on the payload; and
providing, with the suspension lines, reactive forces between the LTA structure and the payload so as to constrain translational and rotational motion of the payload to define a substantially rigid relationship with respect to the LTA structure.
